(19) United States
(12) Patent Application Publication
(10) Pub. No.: US 2008/0190300 A1
(43) Pub. Date: Aug. 14, 2008

(54) Radiant Oven Having Octagonal Cell and/or Sliding Heating Elements

(76) Inventors: Joseph R. Adamski, Pasadena, CA (US); Matthew J. Adamski, Van Nuys, CA (US)

Correspondence Address: SCHIFF HARDIN, LLP;PATENT DEPARTMENT, 6600 SEARS TOWER, CHICAGO, IL, 60606-6473, US

(21) Appl. No.: 11/913,752

(22) PCT Filed: May 8, 2006
(86) PCT No.: PCT/US2006/017767

§ 371 Date: Nov. 6, 2007

Related U.S. Application Data
(60) Provisional application No. 60/679,210, filed on May 9, 2005.
(60) Provisional application No. 60/679,211, filed on May 9, 2005.

(51) Int. Cl. A21B 1/00

(52) U.S. Cl. 99/341; 219/391

(57) ABSTRACT

An oven cell defines a heating cavity of an oven, and the oven cell generally has a shape in the form of an octagon. Additionally or alternatively, a tray containing a heating element for heating the heating cavity is supported so that the tray can be slid out of and into the oven.

### RELATED APPLICATIONS

The present application claims the benefit of U.S. Provisional Application Ser. No. 60/679,210 filed on May 9, 2005 and of U.S. Provisional Application Ser. No. 60/679,211 filed on May 9, 2005, the disclosure of which is incorporated herein by reference.

### TECHNICAL FIELD OF THE INVENTION

The present invention relates to commercial and/or residential ovens.

### BACKGROUND OF THE INVENTION

Oven cells that are incorporated into residential and/or commercial ovens are, for the most part, designed for mass production. These oven cells define the heating cavity of the oven and are typically formed from two pieces of steel. The cell wrapper, usually a ten feet long piece of low carbon, cold rolled steel, is stamped with various cut-outs for attachment of oven racks, lights, temperature sensors, bake and/or broil elements, etc. The cell back is similarly stamped or deep drawn to allow attachment of a convection baffle, temperature sensors, fan motors, rack supports, etc.

A tangent bender is used to form the cell wrapper into an oven cell having a generally rectangular shape such that the top, bottom, and the left and right sides of the oven cell are all one piece. The ends of the cell wrapper are welded to retain the generally rectangular shape of the heating cavity. The cell back is positioned and welded onto the cell wrapper to create, in effect, a five-sided box, i.e., the top, the bottom, the left side, the right side, and the back of the oven cell. At this point, the oven cell is typically sprayed with porcelain frit, hung on conveyors, fired in an oven at high temperature, cooled, inspected, packed, and shipped to the appliance manufacturer for assembly into a freestanding range or a single or double wall oven.

Tooling for the mass production of these oven cells is expensive, currently ranging from $150,000 to $250,000 depending on the nature and complexity of the formed features required in the cell wrapper and/or the cell back. Because component suppliers continuously improve the design of oven cells, expensive changes to the cell's flat surfaces are often required to accept new sized bake and/or broil heating elements or other market or technology driven features. These design changes require re-tooling, which can be very expensive.

In forming the cell wrapper into the oven cell, the tangent bender currently creates a 90° square or nominal 1″ radius rounded corner in the cell wrapper. This type of corner is not very useful. For example, lighting and other design elements such as illuminating radiant heaters, infrared surface temperature sensors, and exhaust or re-circulating smoke and odor eliminating intake and exhaust ports cannot easily be attached to the corners of the oven cell because such design elements typically require a generally flat panel mount, which is not present in current oven cells.

Moreover, once the oven cavity has been porcelainized, any defect discovered during surface inspection requires the re-firing of the entire oven cell. If the oven cell is damaged because of improper handling in the factory, the entire oven cell might have to be scrapped rather than shipped back to the porcelain house.

Furthermore, current design practice is to mount the bake function of an oven at the bottom area of the oven cell and the broil function at the top area of the oven cell. These bake and broil functions are typically implemented using a so-called calrod heating element, which is placed either below, in, or above the corresponding surface of the oven cell.

When placed below the oven floor, the red-hot (high temperature infrared energy emitting) calrod element heats air in a small plenum which, in turn, heats the underside of the bottom of the oven cell. Free or forced convection over this hot floor panel is used to transfer the heat from the hot floor panel to the air in the heating cavity of the oven. The bottom or floor panel is rarely designed to effectively absorb IR radiation emitted by the heater, and even if it were, the bottom or floor panel would still be limited in its ability to heat oven cavity air because the oven cavity air does not contact the red hot (1800° F.) heating element directly but rather contacts the hot (approximately 600° F.) porcelainized floor panel.

When placed above the bottom of the oven cavity, the red-hot heating element effectively causes highly useful free convective air currents; indeed, proper geometric design of the heating element can optimize this effect to create a highly uniform cell cavity air and wall temperature. Unfortunately, when the calrod heating element is located on the inside of the oven cell and is resting on the floor of the oven cell, it is difficult to clean around the heating element because of its size, shape, and electrical connection to the back wall.

When placed inside the bottom floor of the oven cell, i.e., either cast into or thermally fastened to the bottom of the oven cell, the oven floor metal wall heats rapidly and uniformly. However, the cost of such a heater can be prohibitive, and installation, maintenance, leak proofing, and field service can be difficult. Also, heat transfer is again limited to free or forced air convective heat transfer accomplished by flowing air over the heated floor area.

Then too there are classes of cooking tasks which require significant and uniform power density infrared energy to be directed to the bottom of food items, and in addition require power radiated from the top of the oven cell, as in standard broiling practice. Power uniformity may be accomplished using a calrod heating element having a plurality of passes of high temperature radiators. However, this type of heating element frequently is not used at the bottom of the oven cavity due to oven floor cleanability issues.

Moreover, preheat time in current ovens is proportional to the amount of energy that can be directed into the oven cavity. Preheating of the oven is usually accomplished by use of a bake element mounted either below or on the oven floor, and takes two to three minutes to reach red temperature.

The present invention overcomes one or more of these or other problems.

### SUMMARY OF THE INVENTION

According to one aspect of the present invention, an oven cell defines a heating cavity of an oven, and the heating cavity is arranged to receive food to be heated in the oven. The oven cell comprises a cell top, a cell bottom, first and second vertical sides, and at least one slanted cell member. One of the cell top and the cell bottom is joined to the first vertical side by the at least one slanted cell member so that the at least one slanted cell member is slanted with respect to the first vertical side and with respect to the one of the cell top and the cell bottom, and the at least one slanted cell member has an opening. A light is positioned at the opening to illuminate the heating cavity.

According to another aspect of the present invention, an oven having a heating cavity. The heating cavity is arranged to receive food to be heated in the oven. The oven comprises a cell top, a cell bottom, first and second vertical sides, and a tray. The first and second vertical sides are joined to the cell top and the cell bottom to define an oven cell surrounding the heating cavity. The tray contains a heating element. At least one of the cell top and the cell bottom has an opening, and the tray is mounted at the opening in a position to heat the heating cavity. The tray is supported to the one of the cell top and the cell bottom so that the tray can be slid out of and into the oven.

According to still another aspect of the present invention, an oven comprising an oven cell and a tray member. The oven cell has a cell top, a cell bottom, first and second vertical sides, first, second, third, and fourth slanted cell members, and first and second lights. The first, second, third, and fourth slanted cell members join the cell top and the cell bottom to the first and second vertical sides so that the oven cell has a shape generally of a octagon. The first and second slanted cell members have corresponding first and second openings. The first and second lights are positioned at the first and second openings, respectively, so that first and second lights illuminate a heating cavity defined by the oven cell. The tray member contains a heating element and insulation, and the tray member is supported to one of the cell top and the cell bottom so that the tray member can be slid out of and into the oven.

### BRIEF DESCRIPTION OF THE DRAWINGS

These and other features and advantages will become more apparent from a detailed consideration of the invention when taken in conjunction with the drawings in which:

FIG. 1 illustrates an oven cell with a front baffle and panel according to one embodiment of the present invention;

FIG. 2 illustrates the oven cell of FIG. 1 without the front baffle and panel;

FIG. 3 illustrates a back panel that closes the rear of the oven cell shown in FIG. 1;

FIG. 4 illustrates a combination of an oven bottom member and a tray that can be used with the oven cell of FIGS. 1 and 2;

FIG. 5 illustrates the oven cell of FIGS. 1 and 2 with the tray top mounted;

FIG. 6 is a cross section of a heating element including the tray and a heater;

FIG. 7 illustrates a heating element including the tray and the heater of FIG. 6;

FIG. 8 is a cross-section side view of the heating element of FIGS. 6 and 7 with a glass shield;

FIG. 9 illustrates supports for the heating element of FIGS. 6 and 7;

FIG. 10 illustrates the relationship between the heating element of FIGS. 6 and 7 and the bottom of the oven cell shown in FIGS. 1 and 2;

FIG. 11 illustrates the relationship between the oven cell, the heating element of FIGS. 6 and 7 at the cell bottom, and the oven bottom member;

FIG. 12 illustrates a glass frame that can be used in connection with the heating element of FIGS. 6 and 7 mounted at the cell top of the oven cell;

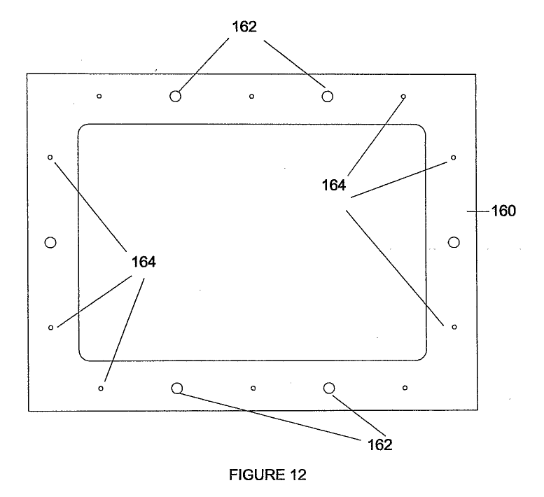

FIG. 13 illustrates the heating element of FIGS. 6 and 7 mounted to the cell top of the oven cell; and,

FIG. 14 shows the oven cell of FIGS. 1 and 2 with illuminating lights mounted thereto.

### DETAILED DESCRIPTION

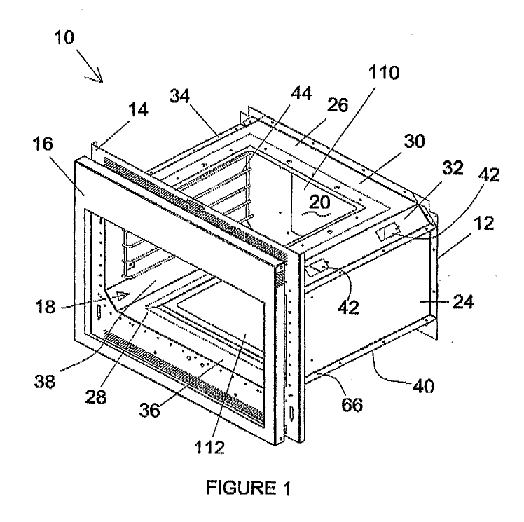

FIG. 1 shows, in part, an oven 10. While the example embodiment of the present invention as shown in FIG. 1 is a single oven, the present invention may be implemented as a double oven, a free standing stove, etc. The oven 10 has an oven cell 12, a front baffle 14 suitably attached to the oven cell 12, and a front panel 16 suitably attached to the front baffle 14. The front baffle 14 and the front panel 16 are configured to provide an opening 18 that permits access to a heating cavity 20 defined by the oven cell 12 and that may be closed off.

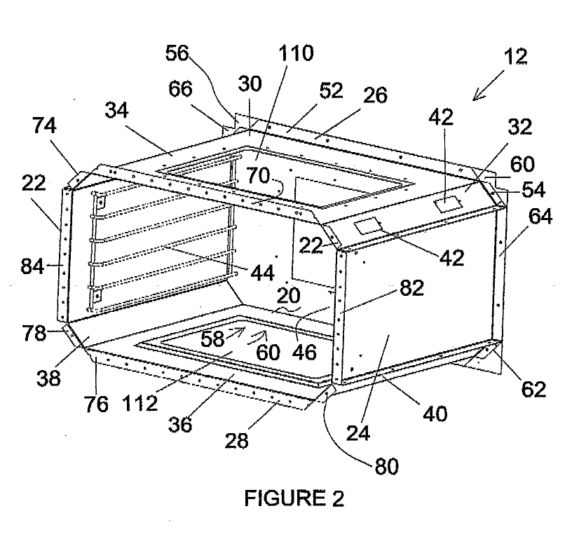

As shown in FIGS. 1 and 2, the oven cell 12 has vertical cell side walls 22 and 24, a cell top 26, and a cell bottom 28. The cell top 26 of the oven cell 12 has a horizontal section 30 and slanted sections 32 and 34 at either end of the horizontal section 30. The slanted sections 32 and 34 are substantially flat. As desired, the cell top 26 of the oven cell 12 may be formed from a single sheet of metal, which is bent near its ends to form the slanted sections 32 and 34, and is stamped or otherwise processed as necessary to form the various openings and/or windows in the cell top 26 as shown in the drawings and as described herein.

Similarly, the cell bottom 28 of the oven cell 12 has a horizontal section 36 and slanted sections 38 and 40 at either end of the horizontal section 36. The slanted sections 38 and 40 are substantially flat. As desired, the cell bottom 28 of the oven cell 12 may be formed from a single sheet of metal, which is bent near its ends to form the slanted sections 38 and 40, and is stamped or otherwise processed as necessary to form the various openings and/or windows in the cell bottom 28 as shown in the drawings and as described herein.

The slanted sections 34 and 38 are suitably attached to the vertical cell side 22 and the slanted sections 32 and 40 are suitably attached to the vertical cell side 24 to form the oven cell 12. Accordingly, as viewed from the front or rear, the oven cell 12 has an octagonal appearing shape.

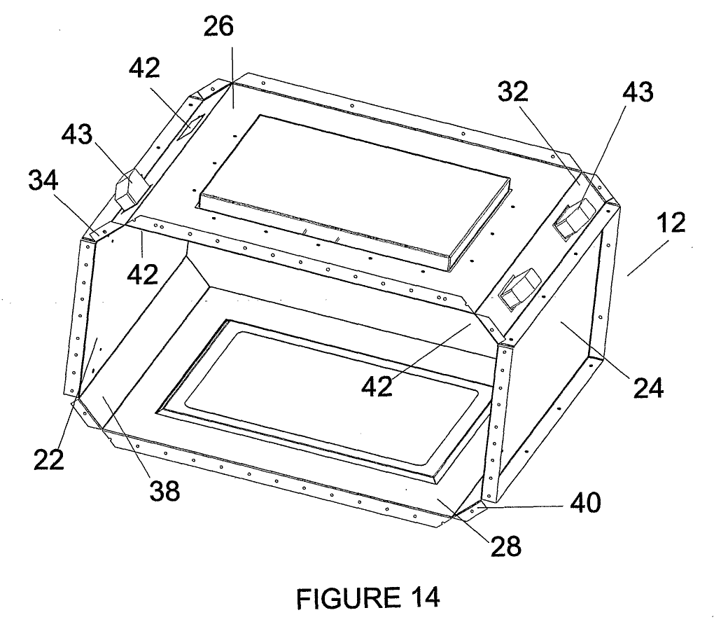

Each of the slanted sections 32 and 34 of the cell top 26 has one or more light windows 42 that allow light from light sources to illuminate the heating cavity 20. As shown in FIG. 14, lights 43 are mounted at the light windows 42 in order to illuminate the heating cavity 14.

As shown in the drawings, the slanted sections 38 and 40 of the cell bottom 28 are not formed with light windows. However, the slanted sections 38 and 40 could be provided with light windows and, if so, the number of separate parts required in inventory for the manufacture of the oven 10 would be reduced.

Instead of forming the cell top 26 with the horizontal section 30 and the slanted sections 32 and 34 from a single piece of material, and instead of forming the cell bottom 28 with the horizontal section 36 and the slanted sections 38 and 40 from a single piece of material, the horizontal section 30 and the slanted sections 32 and 34 may instead be fabricated as three separate pieces, and/or the horizontal section 36 and the slanted sections 38 and 40 may instead be fabricated as three separate pieces. Accordingly, this construction requires that eight pieces, including the vertical cell side walls 22 and 24 and exclusive of the front and back pieces, be suitably fastened together to form the oven cell 12.

Rack supports 44 and 46 are suitably attached to the vertical cell side walls 22 and 24, respectively, so as to support oven racks (not shown).

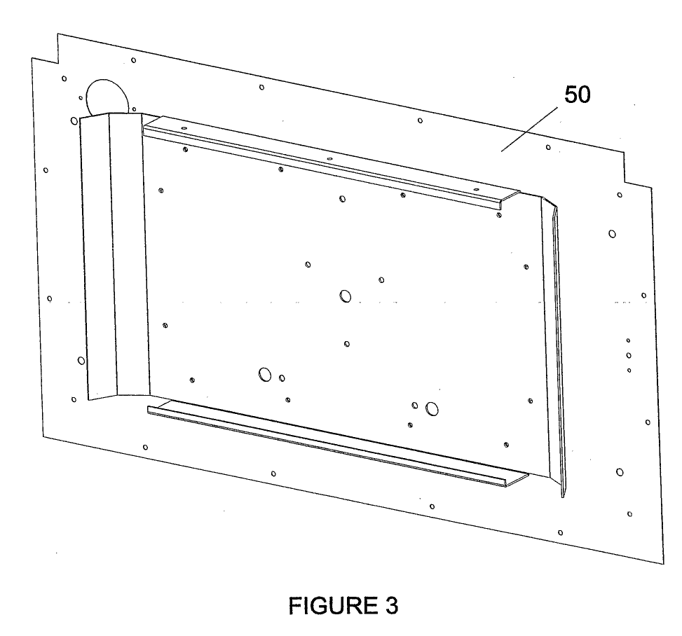

FIG. 3 shows a back panel 50 that is suitably fastened to a flange 52 of the horizontal section 30 of the cell top 26, to a flange 54 of the slanted section 32 of the cell top 26, to a flange 56 of the slanted section 34 of the cell top 26, to a flange 58 of the horizontal section 36 of the cell bottom 28, to a flange 60 of the slanted section 38 of the cell bottom 28, to a flange 62 of the slanted section 40 of the cell bottom 28, to a flange 64 of the vertical cell side 22, and to a flange 66 of the vertical cell side 22. The back panel 50 has holes for mounting various devices such as a temperature sensor, a fan, and/or other devices.

Similarly, the front baffle 14 is suitably fastened to a flange 70 of the horizontal section 30 of the cell top 26, to a flange 72 of the slanted section 32 of the cell top 26, to a flange 74 of the slanted section 34 of the cell top 26, to a flange 76 of the horizontal section 36 of the cell bottom 28, to a flange 78 of the slanted section 38 of the cell bottom 28, to a flange 80 of the slanted section 40 of the cell bottom 28, to a flange 82 of the vertical cell side 22, and to a flange 84 of the vertical cell side 24.

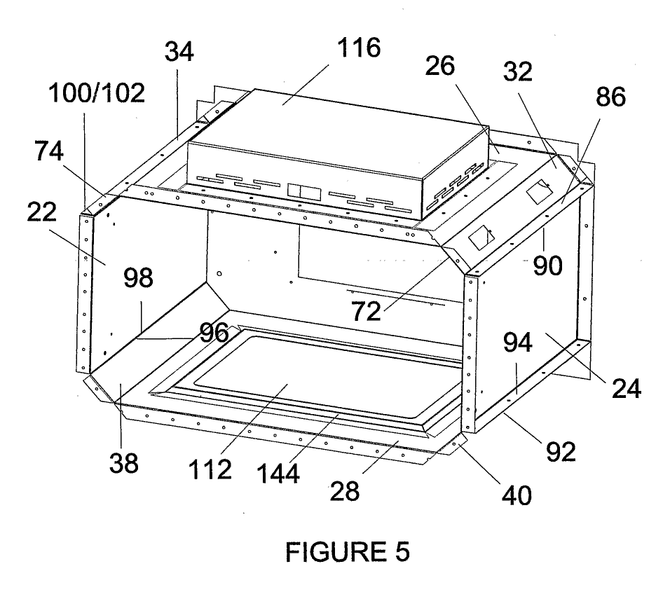

In addition, as shown in FIG. 5, the slanted section 32 has a flange 86 and the vertical cell side 24 has a flange 90 that are used to fasten the slanted section 32 to the vertical cell side 24, the slanted section 40 has a flange 92 and the vertical cell side 24 has a flange 94 that are used to fasten the slanted section 40 to the vertical cell side 24, the slanted section 38 has a flange 96 and the vertical cell side 22 has a flange 98 that are used to fasten the slanted section 38 to the vertical cell side 22, and the slanted section 34 has a flange 100 and the vertical cell side 22 has a flange 102 that are used to fasten the slanted section 34 to the vertical cell side 22.

Thus, the oven cell 12 is octagonal in shape and has improved lighting. The configuration of the oven cell 12 can be readily used in the manufacture of residential and/or commercial heating and cooking equipment. The oven cell 12 consists of common and rotationally symmetrical left and right sides. The cell top 26 and the cell bottom 28 are rotationally symmetrical and, as discussed above, can also be common. The slanted sections 32, 34, 38, and 40 are formed as flanges at angles, such as 45 degree angles, with respect to the horizontal section 30 of the cell top 26 and the horizontal section 36 of the cell bottom 28. Since the slanted sections 32, 34, 38, and 40 are symmetrical, errors in assembly of the oven cell 12 are materially reduced. The cell top 26, the cell bottom 28, and the vertical cell side walls 22 and 24 may be assembled using standard fasteners, such as machine screws, lock washers and nuts or rivets. The back panel 50 and the front baffle 14 may be fastened to the cell top 26, the cell bottom 28, and the vertical cell side walls 22 and 24 and the front panel 16 may be fastened to the front baffle 14 using similar fasteners. Design elements such as rack supports, lighting, temperature sensors, intake or exhaust ports can be readily formed into these small panels.

By decomposing the oven cell into a set of formed panels with specifically featured corner elements, a series of problems are solved.

Design changes to relocate temperature sensors, heater brackets, bake or broil element cut-outs become inexpensive, because these changes affect much smaller parts—nominally two feet long (rather than ten feet long steel elements). In fact, deep draws to create wells or plateaus and other more complicated forms can be more readily accomplished in smaller pieces because the material required for the draw is often supplied by the neighboring steel surface and so, greater care must be take to maintain adjacent features in much bigger sheets.

Corner illumination of food product positioned on cell racks is a valuable feature. Industry standard white light halogen lighting usually attached to standard practice oven cells on the top (looking downward) or on the sides (looking sideward) is ineffective because, most often and especially with professional style convection cooking appliances, several layers of food on racks are present in the oven. Food or ovenware placed on these racks block top lighting, and lights are generally not supplied in sufficient quantity to illuminate each of five racks typically found in professional cooking ovens. Side lighting creates direct line of sight of the bulb filament, often “blinding” the observer because the intensity of the light source is greater than the intensity of reflected light from the object to be observed.

Lighting of the heating cavity 14 may be provided from top, bottom, and left and right corners. In the case of bottom light application, the lights may be located close to the door and shielded from direct line of sight by the door glass and metal support structures. Furthermore, radiant heaters are more readily positioned in these locations for improved illumination. In addition and directly resulting from the need to insulate the oven cell (which may operate at a temperature as high as 950F), the corners are ideally suited for lighting or radiant heating design elements because of the additional volume obtained at the corners that may be used for insulating. Standard practice wall lighting forces the designer to extend insulation by the depth of the light enclosure. Since the range or oven must fit in a standard size kitchen cabinet, side mounted lighting reduces the available width and subsequent volume of the heating cavity.

In the event of shipping damage, assembly line damage, or even household damage, a small panel may be less expensively scrapped when compared to destroying the entire cell. The economic impact of this savings is potentially very high. Handling, porcelain spray, porcelain oven hanging and throughput, operator fatigue, shipping, warehousing, assembly line setup, assembler skill level, and even end-of-life recycling are favorably impacted by this modular panel approach.

To manufacture the oven cell 12, the vertical cell side walls 22 and 24, the cell top 26, and the cell bottom 28 may be made from stainless steel (for lower temperature applications such as warming ovens) or low carbon, cold rolled steel (for higher temperature, porcelainized parts). Sheets of the steel may be blanked to size either at the steel supplier or in-house. Various features may be stamped or otherwise formed in the common cell top 26, the cell bottom 28, the common vertical cell side walls 22 and 24 using smaller, less expensive equipment, such as a turret press, at the appliance manufacturer. The flat patterns are turned into generally eight sided boxes using a less expensive bending brake.

The flanges of the oven cell 12, the vertical cell side walls 22 and 24, the cell top 26, and the cell bottom 28, for example, may be one inch wide, 90° flanges that are pre-punched to receive machine screw fasteners or rivets. The slanted sections 32, 34, 38 and/or 40 are stamped or otherwise formed with lighting cut-outs and are formed at 45° angles with respect to the vertical cell side walls 22 and 24, the cell top 26, and the cell bottom 28. If the slanted sections 32, 34, 38, and 40 are formed as pieces separate from the cell top 26 and the cell bottom 28, the slanted sections 32, 34, 38, and 40 and the cell top 26 and the cell bottom 28 may be formed with suitable aligning edges or flanges to allow their attachment to the cell top 26 and the cell bottom 28.

As shown in FIGS. 1 and 2, the cell top 26 of the oven cell 12 has a cut out 110, and the cell bottom 28 of the oven cell 12 has a similar cut out 112. The cut out 110 and the cut out 112 are arranged to each receive a heating element 114.

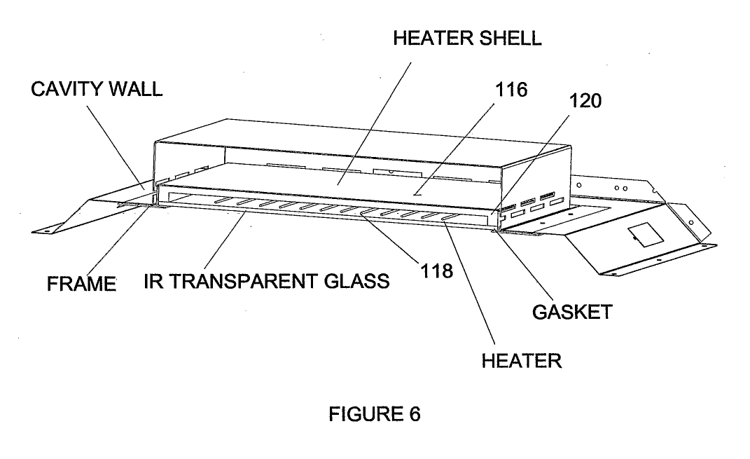

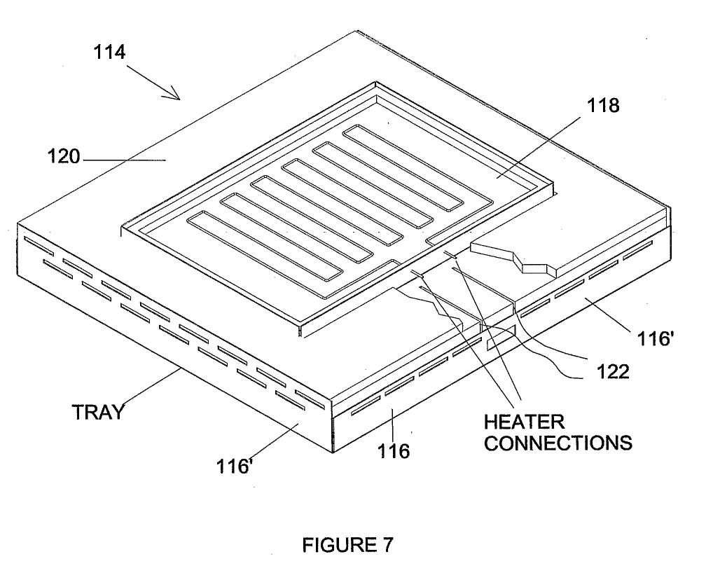

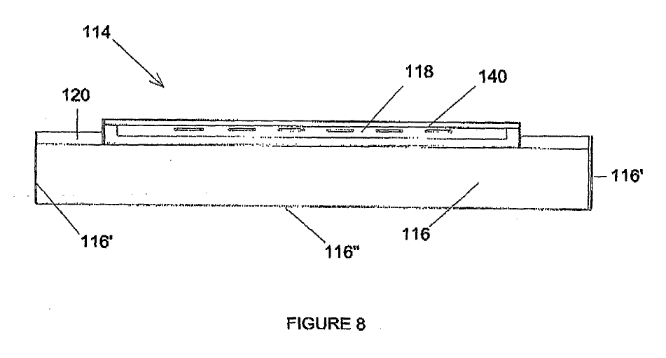

As shown in FIGS. 6, 7, and 8, the heating element 114 has a tray 116, a heater 118, and insulation 120. The heater 118, for example, may be a calrod or a low thermal mass, radiant heating element such as supplied by Ceramaspeed. Such a low thermal mass element takes approximately three to four seconds to achieve glow. As shown in FIG. 8, the heater 118 is partially embedded in the insulation 120, and the insulation 120 is contained within the four sides 116′ and floor 116″ of the tray 116. The insulation 120 may comprise one or more boards. The heater 118 has electrical wires 122 that are used to supply power to the heater 118. The electrical wires 122 may be terminated in quick connects or may have terminations similar to those used in connection with heating coils for stove top use.

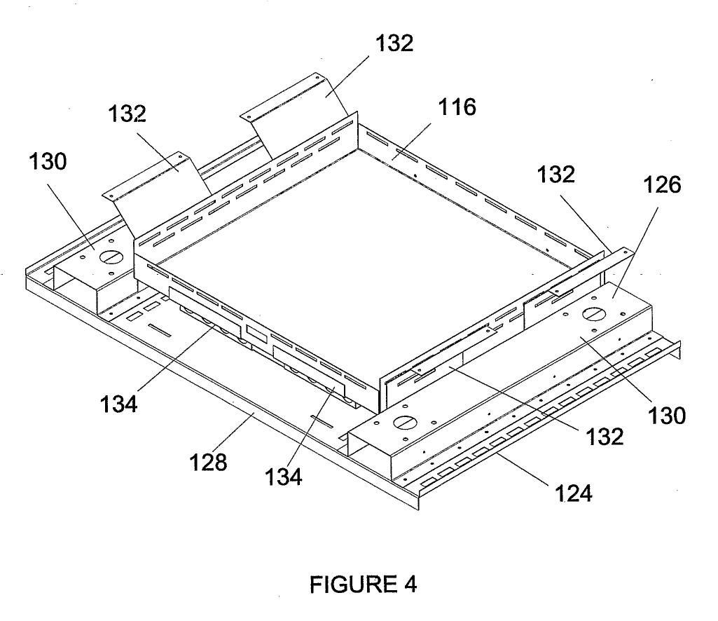

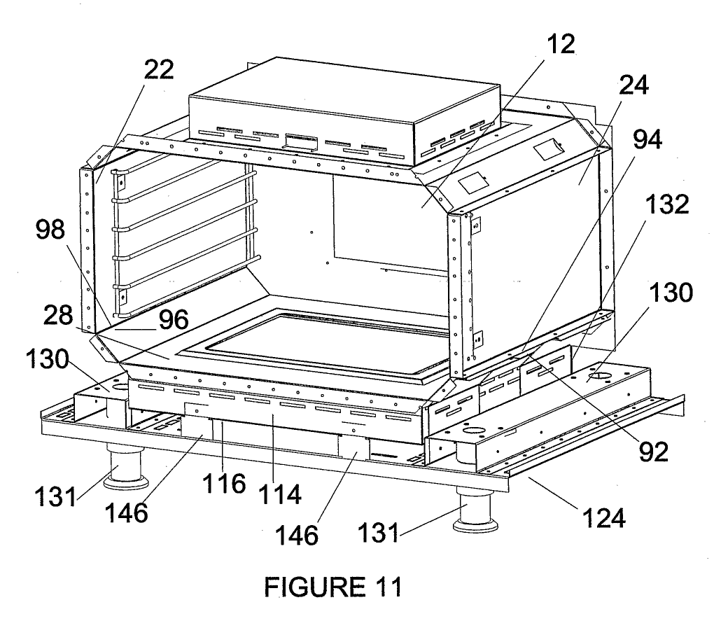

One instantiation of the heating element 114 can be used at the cut out 110, and another instantiation of the heating element 114 can be used at the cut out 112. When used at the cut out 112, the tray 116 can be slid into and out of the oven 10. Accordingly, as shown in connection with FIG. 4, the oven 10 includes an oven bottom member 124 having a front 126 that faces the user when installed and a back 128 that faces away from the user. The oven bottom member 124 includes foot hats 130 that receive adjustable feet 131 (see FIG. 11) to adjustably support the oven 10 on a floor or in a cabinet. The oven bottom member 124 has flanges 132 having holes that suitably mate with corresponding holes in the flanges 92, 94, 96, and 98 (see FIGS. 5 and 11) in order to fasten the oven bottom member 124 to the oven cell 12. The oven bottom member 124 also has stops 134 that stop the tray 116 as the heating element 114 is slid into the over 10 between the oven bottom member 124 and the oven cell 12.

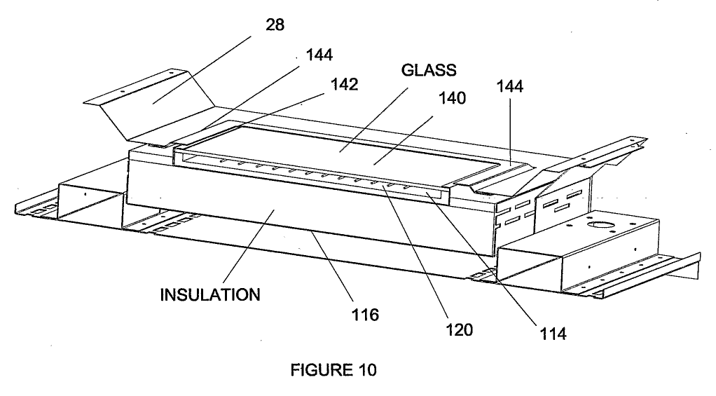

As shown in FIGS. 8 and 10, a glass shield 140 is placed over the heating element 114. As shown in FIG. 10, a sealing gasket 142 is placed around an outer perimeter of the glass shield 140 so that the glass shield 140 is between the heating element 114 and the sealing gasket 142. The glass shield 140 is preferably made from a high temperature glass. For example, the glass shield 140 may be generally constructed from Schott Ceran or Robax glass, a material that exhibits very high transparency in the infrared region of the electromagnetic spectrum. The sealing gasket 142 is preferably a high temperature ceramic sealing gasket. When the heating element 114 is fully slid into the oven 10 until the tray 116 hits the stops 134, the sealing gasket 142 abuts a lip 144 (also shown in FIG. 5) of the cell bottom 28. The lip 144 defines the opening 112 in the cell bottom 28.

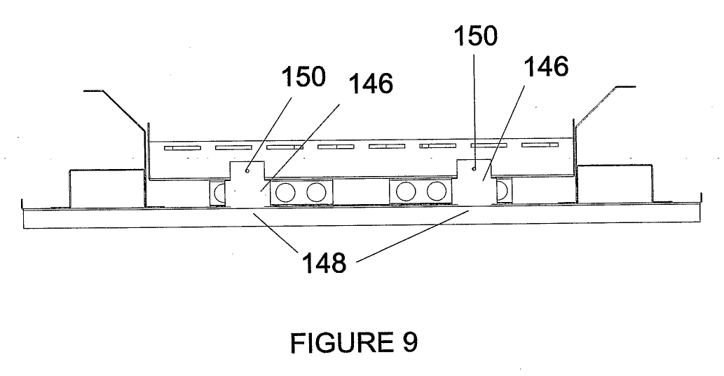

As shown in FIG. 9, tray supports 146 are used to support the tray 116 to the oven bottom 124. The tray supports 146, for example, may be in the shape of crosses, and are inserted at one end 148 into corresponding slots in the oven bottom member 124 and are fastened to the tray 116 by use of fasteners that are inserted through holes 150 in the tray supports 146 and corresponding holes in the tray 116.

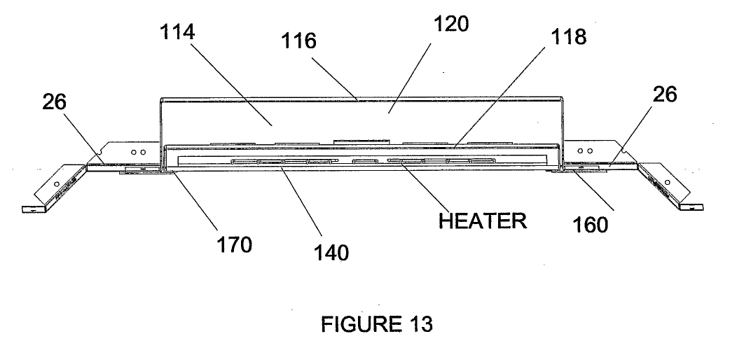

When used at the cut out 110, the heating element 114 with the glass shield 140 is inverted and is inserted through the cut out 110 from inside the heating cavity 14. Accordingly, the tray 116 protrudes from the cell top 26 as shown in FIGS. 5 and 13.

A frame 160 is used to hold the glass shield 140 in place. The frame 160 has large holes 162 and small holes 164. Fasteners inserted through the large holes 162 secure the tray 116 holding the heater 118 and the insulation 120 to the cell top 26, and fasteners inserted through the small holes 164 secure the frame 160 to the cell top 26 so that the glass shield 140 is held in place.

Accordingly, if the glass shield 140 requires servicing, the fasteners in the small holes 164 are removed and only the frame 160 and the glass shield 140 drop into the heating cavity 14 and the glass shield 140 may then be serviced.

On the other hand, if the heating element 114 is to be removed, the fasteners in both the large holes 162 and in the small holes 164 are removed. In this case, the heating element 114, the frame 160, and the glass shield 140 drop into the heating cavity 14 and can then be removed from the oven 10.

A sealing gasket 170 is provided between the cell top 26 and the frame 160. Alternatively, the sealing gasket 170 could be between the glass shield 140 and the frame 160. The sealing gasket 170 is preferably a high temperature ceramic sealing gasket.

The glass shield 140, for example, may be transparent and further may be a highly infrared energy transparent glass shield. The heater 118, which, for example, may be an IR radiating element, is mounted in the bake position in tray 116 that holds and retains glass shield 140, the heater 118, and the insulation 120 and that extends a nominal distance (½ inch to ¾ inch) into the heating cavity 14, thus forming a flat and cleanable glass plateau capable of shedding substantial amounts of fluid spills into the surrounding cell bottom 28. Substantially the same arrangement is used in the broil position at the top of the oven cell 12. Thin, ceramic fiber material (such as manufactured by Lydall Technical Papers) may be placed between the glass shield 140 and the oven cell 12 to insulate, seal, and absorb shocks to the glass shield 140.

Certain modifications of the present invention have been discussed above. Other modifications of the present invention will occur to those practicing in the art of the present invention. For example, as described above, the frame 160 has both large holes providing access to the fasteners that fasten the heating element 114 to the cell top 26 and small holes for receiving fasteners that fasten the frame 160 to the cell top 26. Alternatively, the frame 160 may instead have only the small holes that receive fasteners that fasten the frame 160 to the cell top 26. In this case, the frame 160 would cover that the fasteners that fasten the heating element 114 to the cell top 26.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

What is claimed is:

1. An oven cell that defines a heating cavity of an oven, wherein the heating cavity is arranged to receive food to be heated in the oven, and wherein the oven cell comprises:
a cell top;
a cell bottom;
first and second vertical sides;
at least one slanted cell member, wherein one of the cell top and the cell bottom is joined to the first vertical side by the at least one slanted cell member so that the at least one slanted cell member is slanted with respect to the first vertical side and with respect to the one of the cell top and the cell bottom, and wherein the at least one slanted cell member has an opening; and,
a light positioned at the opening to illuminate the heating cavity.

2. The oven cell of claim 1 wherein the at least one slanted cell member comprises at least first and second slanted cell members, wherein one of the cell top and the cell bottom is joined to the first and second vertical sides by the at least first and second slanted cell members so that the at least first and second slanted cell members are slanted with respect to the first and second vertical sides and with respect to the one of the cell top and the cell bottom.

3. The oven cell of claim 2 wherein the first slanted cell member has a first opening, wherein the second slanted cell member has a second opening, wherein the light comprises first and second lights, wherein the first light is positioned at the first opening to illuminate the heating cavity, and wherein the second light is positioned at the second opening to illuminate the heating cavity.

4. The oven cell of claim 1 wherein the at least one slanted cell member comprises first, second, third, and fourth slanted cell members, wherein the cell top is joined to the first and second vertical sides by the first and second slanted cell members so that the first and second slanted cell members are slanted with respect to the first and second vertical sides and with respect to the cell top, wherein the cell bottom is joined to the first and second vertical sides by the third and fourth slanted cell members so that the third and fourth slanted cell members are slanted with respect to the first and second vertical sides and with respect to the cell bottom, and wherein the first, second, third, and fourth slanted cell members, the cell top, the cell bottom, and the first and second vertical sides form the oven cell in a generally octagonal shape.

5. The oven cell of claim 4 wherein at least two of the first, second, third, and fourth slanted cell members have corresponding first and second openings, wherein the light comprises first and second lights, wherein the first light is positioned at the first opening to illuminate the heating cavity, and wherein the second light is positioned at the second opening to illuminate the heating cavity.

6. The oven cell of claim 1 wherein at least one of the cell top and the cell bottom has an opening, wherein a tray is mounted at the opening, wherein the tray contains a heating element for heating the heating cavity, and wherein the tray is supported to the one of the cell top and the cell bottom so that the tray can be slid out of and into the oven.

7. The oven cell of claim 6 wherein the heating element comprises a low thermal mass, radiant heating element that takes approximately three to four seconds to achieve glow.

8. The oven cell of claim 1 wherein the cell top and the cell bottom have corresponding first and second openings, wherein a first tray is mounted at the first opening, wherein a second tray is mounted at the second opening, wherein the first and second trays contain corresponding first and second heating elements for heating the heating cavity, and wherein at least one of the first and second trays is supported to the corresponding one of the cell top and the cell bottom so that the one of the first and second trays can be slid out of and into the oven.

9. The oven cell of claim 8 wherein each of the first and second heating elements comprises a low thermal mass, radiant heating element that takes approximately three to four seconds to achieve glow.

10. The oven cell of claim 1 wherein the cell top and the cell bottom have corresponding first and second openings, wherein a first tray is mounted at the first opening, wherein a second tray is mounted at the second opening, wherein the first and second trays contain corresponding first and second heating elements for heating the heating cavity, wherein the first tray is fastened to the cell top by fasteners so that, when the first tray is unfastened, the first tray drops down into the heating cavity and away from the first opening, and wherein the second tray is supported to the cell bottom so that the second tray can be slid out of and into the oven.

11. The oven cell of claim 9 wherein each of the first and second heating elements comprises a low thermal mass, radiant heating element that takes approximately three to four seconds to achieve glow.

12. An oven having a heating cavity, wherein the heating cavity is arranged to receive food to be heated in the oven, and wherein the oven comprises:
a cell top;
a cell bottom;
first and second vertical sides, wherein the first and second vertical sides are joined to the cell top and the cell bottom to define an oven cell surrounding the heating cavity;
a tray containing a heating element, wherein at least one of the cell top and the cell bottom has an opening, wherein the tray is mounted at the opening in a position to heat the heating cavity, and wherein the tray is supported to the one of the cell top and the cell bottom so that the tray can be slid out of and into the oven.

13. The oven of claim 12 wherein the heating element comprises a low thermal mass, radiant heating element that takes approximately three to four seconds to achieve glow.

14. The oven of claim 12 wherein the cell top and the cell bottom have corresponding first and second openings, wherein the tray comprises a first tray, wherein the heating element comprises a first heating element, wherein the oven cell includes a second tray containing a second heating element, wherein the first tray is mounted at the first opening in a position to heat the heating cavity, wherein the second tray is mounted at the second opening in a position to heat the heating cavity, and wherein at least one of the first and second trays is supported to the corresponding one of the cell top and the cell bottom so that the one of the first and second trays can be slid out of and into the oven.

15. The oven of claim 14 wherein each of the first and second heating elements comprises a low thermal mass, radiant heating element that takes approximately three to four seconds to achieve glow.

16. The oven of claim 12 wherein the cell top and the cell bottom have corresponding first and second openings, wherein the tray comprises a first tray, wherein the heating element comprises a first heating element, wherein the oven cell includes a second tray containing a second heating element, wherein the first tray is mounted at the first opening in a position to heat the heating cavity, wherein the second tray is mounted at the second opening in a position to heat the heating cavity, wherein the first tray is fastened to the cell top by fasteners so that, when the first tray is unfastened, the first tray drops down into the heating cavity and away from the first opening, and wherein the second tray is supported to the cell bottom so that the second tray can be slid out of and into the oven.

17. The oven of claim 16 wherein each of the first and second heating elements comprises a low thermal mass, radiant heating element that takes approximately three to four seconds to achieve glow.

18. The oven of claim 12 further comprising an oven bottom that supports the oven cell on a supporting surface, wherein the oven bottom is configured such that the tray can be slid into the oven between the oven bottom and the cell bottom.

19. The oven of claim 12 further comprising at least one slanted cell member and a light, wherein one of the cell top and the cell bottom is joined to the first vertical side by the at least one slanted cell member so that the at least one slanted cell member is slanted with respect to the first vertical side and with respect to the one of the cell top and the cell bottom, wherein the at least one slanted cell member has a light opening, and wherein the light is positioned at the light opening to illuminate the heating cavity.

20. The oven of claim 12 further comprising at least first and second slanted cell members and a light, wherein one of the cell top and the cell bottom is joined to the first and second vertical sides by the at least first and second slanted cell members so that the at least first and second slanted cell members are slanted with respect to the first and second vertical sides and with respect to the one of the cell top and the cell bottom, wherein at least one of the at least first and second slanted cell members has a light opening, and wherein the light is positioned at the light opening to illuminate the heating cavity.

21. The oven of claim 20 wherein the first slanted cell member has a first light opening, wherein the second slanted cell member has a second light opening, wherein the light comprises first and second lights, wherein the first light is positioned at the first light opening to illuminate the heating cavity, and wherein the second light is positioned at the second light opening to illuminate the heating cavity.

22. The oven of claim 12 further comprising first, second, third, and fourth slanted cell members and a light, wherein the cell top is joined to the first and second vertical sides by the first and second slanted cell members so that the first and second slanted cell members are slanted with respect to the first and second vertical sides and with respect to the cell top, wherein the cell bottom is joined to the first and second vertical sides by the third and fourth slanted cell members so that the third and fourth slanted cell members are slanted with respect to the first and second vertical sides and with respect to the cell bottom, wherein the first, second, third, and fourth slanted cell members, the cell top, the cell bottom, and the first and second vertical sides form the oven cell in a generally octagonal shape, wherein at least one of the first, second, third, and fourth slanted cell members has a light opening, and wherein the light is positioned at the light opening to illuminate the heating cavity.

23. The oven of claim 22 wherein at least two of the first, second, third, and fourth slanted cell members have corresponding first and second light openings, wherein the light comprises first and second lights, wherein the first light is positioned at the first light opening to illuminate the heating cavity, and wherein the second light is positioned at the second light opening to illuminate the heating cavity.

24. An oven comprising:
an oven cell having a cell top, a cell bottom, first and second vertical sides, first, second, third, and fourth slanted cell members, and first and second lights, wherein the first, second, third, and fourth slanted cell members join the cell top and the cell bottom to the first and second vertical sides so that the oven cell has a shape generally of a octagon, wherein the first and second slanted cell members have corresponding first and second openings, and wherein the first and second lights are positioned at the first and second openings, respectively, so that first and second lights illuminate a heating cavity defined by the oven cell; and,
a tray member containing a heating element and insulation, wherein the tray member is supported to one of the cell top and the cell bottom so that the tray member can be slid out of and into the oven.

25. The oven of claim 24 wherein the first and second slanted cell members join the cell top to the first and second vertical sides, wherein the third and fourth slanted cell members join the cell bottom to the first and second vertical sides.

26. The oven of claim 24 wherein each of the heating element comprises a low thermal mass, radiant heating element that takes approximately three to four seconds to achieve glow.

27. The oven of claim 24 wherein the tray member is supported to the cell bottom so that the tray member can be slid out of and into the oven, and wherein the cell bottom has a window permitting radiation from the heating element to enter the heating cavity.

28. The oven of claim 27 wherein each of the heating element comprises a low thermal mass, radiant heating element that takes approximately three to four seconds to achieve glow.

29. The oven of claim 27 further comprising an oven bottom that supports the oven cell on a supporting surface, wherein the oven bottom is configured such that the tray can be slid into the oven between the oven bottom and the cell bottom.
